(19) United States
(12) Patent Application Publication
(10) Pub. No.: US 2025/0200408 A1
(43) Pub. Date: Jun. 19, 2025

(54) QUANTUM CIRCUIT SIMULATION DEVICE AND METHOD

(71) Applicant: POSTECH RESEARCH AND BUSINESS DEVELOPMENT FOUNDATION, Pohang-si (KR)

(72) Inventors: Seok Hyeong KANG, Pohang-si (KR); Jae Kyung IM, Pohang-si (KR)

(73) Assignee: POSTECH RESEARCH AND BUSINESS DEVELOPMENT FOUNDATION, Pohang-si (KR)

(21) Appl. No.: 18/969,097

(22) Filed: Dec. 4, 2024

(30) Foreign Application Priority Data
Dec. 14, 2023 (KR) 10-2023-0182284

(51) Int. Cl. G06N 10/20; G06N 10/60

(52) U.S. Cl. CPC G06N 10/20; G06N 10/60

(57) ABSTRACT

A quantum circuit simulation device comprising, a memory, a processor operatively connected to the memory, wherein the processor, calculates the weight of a first quantum circuit including at least two qubits and multi-gates connecting the at least two qubits, determines a cutting line that minimizes the number of cuts in the multi-gates based on the weight when dividing the at least two qubits into two groups, determines a second quantum circuit by dividing the first quantum circuit into a first group and a second group along the cutting line, rearranging the at least two qubits, calculates a final operation value by merging a first operation value of the first group and a second operation value of the second group in the second quantum circuit, and rearranges the at least two qubits of the second quantum circuit to be the same as the first quantum circuit.

### CROSS-REFERENCE TO RELATED APPLICATION

This application claims priority under 35 U.S.C. § 119 to Korean Patent Application No. 10-2023-0182284 filed on Dec. 14, 2023, in the Korean Intellectual Property Office, the entire contents of which are hereby incorporated by reference.

### TECHNICAL FIELD

The present disclosure relates to a quantum circuit simulation device and method. Specifically, the present disclosure pertains to a device and method for generating a weighted graph, partitioning a quantum circuit, and simulating the quantum circuit.

### BACKGROUND

Quantum circuit simulation refers to implementing the execution results of a quantum computer on a classical computer. A quantum computer processes information based on the principles of quantum mechanics, but it has not yet been commercialized. Therefore, quantum computers are currently emulated using classical computers, which is referred to as quantum circuit simulation.

During the computational process of a quantum computer, large-scale matrix operations are required. In other words, the time and cost involved in the computational process are enormous. To address the complexity of quantum circuit simulation, the Hybrid Schrödinger-Feynman (HSF) method has been proposed.

The HSF method merges the Schrodinger method and the Feynman method. That is, the HSF method simulates a quantum circuit by dividing it into two halves and performing quantum circuit simulations according to the possible states.

However, the HSF method has the drawback that the time required to compute large quantum circuits increases exponentially. Therefore, there is a need for a more efficient computational method, rather than simply dividing the quantum circuit into two halves.

### PRIOR ART DOCUMENTS

### Patent Documents

Korean Patent Application Publication No. 10-2023-0155760

### SUMMARY

An object of the present disclosure is to provide a method for reducing the number of possible states in quantum circuit simulation using an algorithm.

Another object of the present disclosure is to minimize the number of divided multi-gates, thereby reducing the time required for the overall quantum circuit simulation.

Yet another object of the present disclosure is to provide a method for efficiently restoring the quantum circuit to the same form as the input.

The objects of the present disclosure are not limited to those objects mentioned above. Other objects and advantages of the present disclosure, which are not explicitly stated, can be understood from the following descriptions and will become more apparent through the embodiments of the present disclosure. Furthermore, it will be easily understood that the objects and advantages of the present disclosure can be achieved by the means and combinations thereof described in the claims.

According to some aspects of the disclosure, a quantum circuit simulation device comprises, a memory, a processor operatively connected to the memory, wherein the processor, calculates the weight of a first quantum circuit including at least two qubits and multi-gates connecting the at least two qubits, determines a cutting line that minimizes the number of cuts in the multi-gates based on the weight when dividing the at least two qubits into two groups, determines a second quantum circuit by dividing the first quantum circuit into a first group and a second group along the cutting line, rearranging the at least two qubits, calculates a final operation value by merging a first operation value of the first group and a second operation value of the second group in the second quantum circuit, and rearranges the at least two qubits of the second quantum circuit to be the same as the first quantum circuit.

According to some aspects, the calculating the weight of the first quantum circuit comprises, removing a single gate that operates on one of the at least two qubits in the first quantum circuit, determining the weight by counting the multi-gates in the first quantum circuit with the single gate removed; and generating a weighted graph that includes the weight.

According to some aspects, the qubits include a first qubit and a second qubit, and the generating the weighted graph includes displaying the number of first multi-gates connecting the first and second qubits.

According to some aspects, the qubits further include a third qubit, and the generating the weighted graph further includes, displaying the number of second multi-gates connecting the second and third qubits; and displaying the number of third multi-gates connecting the third and first qubits.

According to some aspects, the weighted graph includes straight lines corresponding to the multi-gates and numbers corresponding to the weights.

According to some aspects, the determining the cutting line includes determining a line that divides the quantum circuit by minimizing the number of cuts in the multi-gates according to an algorithm.

According to some aspects, the algorithm includes a Fiduccia-Mattheyses (FM) algorithm.

According to some aspects, the number of cuts includes the number of multi-gates passing through the cutting line in the weighted graph.

According to some aspects, the number of qubits in the first group is at least two greater than the number of qubits in the second group.

According to some aspects, the determining the second quantum circuit includes: dividing into the first and second groups, each including at least one qubit; and rearranging the first and second groups on the quantum circuit according to their respective groups.

According to some aspects, the calculating the final operation value includes: dividing the first and second groups into a predetermined number of layers; calculating the first-1 group value according to the first case of the multi-gates in the first group; calculating the second-1 group value according to the first case of the multi-gates in the second group; and merging the first-1 and second-1 group values.

According to some aspects, the predetermined number is equal to the number of multi-gates.

According to some aspects of the disclosure, a quantum circuit simulation method comprises, calculating the weight of a first quantum circuit that includes at least two qubits and multi-gates connecting the at least two qubits, determining a cutting line that minimizes the number of cuts in the multi-gates based on the weight when dividing the at least two qubits into two groups, determining a second quantum circuit by dividing the first quantum circuit into a first group and a second group along the cutting line, rearranging the at least two qubits, calculating a final operation value by merging a first operation value of the first group and a second operation value of the second group in the second quantum circuit, and rearranging the at least two qubits of the second quantum circuit to be the same as the first quantum circuit.

According to some aspects, the calculating the final operation value comprises: dividing the first and second groups into a number of layers greater than the number of multi-gates; calculating a first-1 group value according to the first case of the multi-gates in the first group; calculating a second-1 group value according to the first case of the multi-gates in the second group; and merging the first-1 and second-1 group values.

According to some aspects, the calculating the first-1 group value further includes: calculating a first-4 group value according to a second case of the multi-gates in the first group, different from the first case.

According to some aspects, the first operation value includes the first-1 group value and the first-4 group value.

According to some aspects, the calculating the second-1 group value further includes: calculating a second-4 group value according to a second case of the multi-gates in the second group.

According to some aspects, the second operation value includes the second-1 group value and the second-4 group value.

According to some aspects, the final operation value includes the sum of a first intermediate operation value, obtained by merging the first-1 group value and the second-1group value, and a fourth intermediate operation value, obtained by merging the first-4 group value and the second-4 group value.

According to some aspects, the calculating the final operation value includes utilizing depth-first search (DFS) on the layers.

According to some aspects, the final operation value includes a value obtained by merging the first-1 group value and the second-1 group value using a predefined method.

According to some aspects, wherein the predefined method includes calculating the Kronecker product of the first-1 group value and the second-1 group value.

The quantum circuit simulation device and method of the present disclosure can derive results for a quantum circuit in the same form as the input by replacing matrix multiplication with bit-level operations.

In addition, the present disclosure can reduce the time required to restore the qubit order by utilizing bit operations.

Furthermore, it can reduce the number of possible states in quantum circuit simulation by employing an algorithm that reduces the number of cuts.

Moreover, the present disclosure can minimize multi-gates, thereby shortening the total time required for the quantum circuit simulation.

Along with the above descriptions, the specific effects of the present disclosure will be explained in detail in conjunction with the specific details for implementing the invention.

### BRIEF DESCRIPTION OF THE DRAWINGS

FIG. 1 is a block diagram illustrating a quantum circuit simulation method and device according to several embodiments of the present disclosure.

FIG. 2 is a flowchart illustrating the quantum circuit simulation method according to several embodiments of the present disclosure.

FIG. 3 is a diagram illustrating a quantum circuit including qubits, single gates, and multi-gates as depicted in FIG. 2.

FIG. 4 is a flowchart illustrating the process of calculating the weight of the first quantum circuit in FIG. 1.

FIG. 5 is a diagram illustrating the preprocessed quantum circuit for generating the weighted graph of FIG. 4.

FIG. 6 is a diagram for explaining the method of calculating the weight in FIG. 4.

FIG. 7 is a diagram illustrating a portion of the weighted graph in FIG. 4.

FIG. 8 is a diagram illustrating the entire weighted graph in FIG. 4.

FIG. 9 is a diagram illustrating the method of determining the number of cuts along the cutting line of FIG. 2.

FIG. 10 is a diagram illustrating the calculation process to minimize the number of cuts in FIG. 2.

FIG. 11 is a diagram illustrating the method of determining the cutting line with the minimized number of cuts in FIG. 2.

FIG. 12 is a flowchart detailing the step of determining the second quantum circuit in FIG. 2.

FIG. 13 is a diagram illustrating the first group and the second group from FIG. 12.

FIG. 14 is a diagram illustrating the second quantum circuit from FIG. 12.

FIG. 15 is a flowchart detailing the step of calculating the final operation value in FIG. 2.

FIG. 16 is a diagram illustrating the layers into which the first group and the second group from FIG. 14 are divided.

FIG. 17 illustrates the method of calculating the first-1 group value in FIG. 15.

FIG. 18 shows the method of calculating the second-1 group value in FIG. 15.

FIG. 19 represents the formula for calculating the final operation value using the first-1 group value and the second-1 group value in FIG. 15.

FIG. 20 is a diagram illustrating the qubit arrangement order before and after the rearrangement of the second quantum circuit in FIG. 2.

FIG. 21 is a diagram illustrating the second quantum circuit before rearrangement in FIG. 2.

FIG. 22 is a diagram illustrating the second quantum circuit after rearrangement in FIG. 2.

FIG. 23 is a chart comparing the efficiency before and after the rearrangement in FIG. 2.

### DETAILED DESCRIPTION

The terms or words used in the disclosure and the claims should not be construed as limited to their ordinary or lexical meanings. They should be construed as the meaning and concept in line with the technical idea of the disclosure based on the principle that the inventor can define the concept of terms or words in order to describe his/her own inventive concept in the best possible way. Further, since the embodiment described herein and the configurations illustrated in the drawings are merely one embodiment in which the disclosure is realized and do not represent all the technical ideas of the disclosure, it should be understood that there may be various equivalents, variations, and applicable examples that can replace them at the time of filing this application.

Although terms such as first, second, A, B, etc. used in the description and the claims may be used to describe various components, the components should not be limited by these terms. These terms are only used to differentiate one component from another. For example, a first component may be referred to as a second component, and similarly, a second component may be referred to as a first component, without departing from the scope of the disclosure. The term ‘and/or’ includes a combination of a plurality of related listed items or any item of the plurality of related listed items.

The terms used in the description and the claims are merely used to describe particular embodiments and are not intended to limit the disclosure. Singular forms are intended to include plural forms unless the context clearly indicates otherwise. In the application, terms such as “comprise,” “comprise,” “have,” etc. should be understood as not precluding the possibility of existence or addition of features, numbers, steps, operations, components, parts, or combinations thereof described herein.

Unless otherwise defined, the phrases “A, B, or C,” “at least one of A, B, or C,” or “at least one of A, B, and C” may refer to only A, only B, only C, both A and B, both A and C, both B and C, all of A, B, and C, or any combination thereof.

Unless being defined otherwise, all terms used herein, including technical or scientific terms, have the same meaning as commonly understood by those skilled in the art to which the disclosure pertains.

Terms such as those defined in commonly used dictionaries should be construed as having a meaning consistent with the meaning in the context of the relevant art, and are not to be construed in an ideal or excessively formal sense unless explicitly defined in the application. In addition, each configuration, procedure, process, method, or the like included in each embodiment of the disclosure may be shared to the extent that they are not technically contradictory to each other.

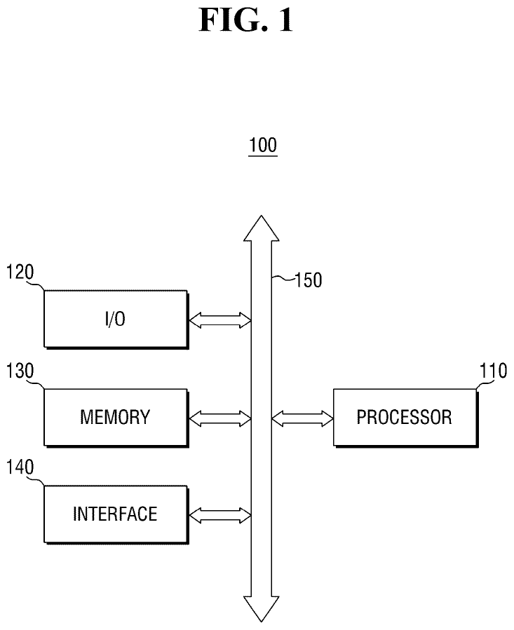

Hereinafter, with reference to FIGS. 1 to 19, a neural processing device according to several embodiments of the present disclosure will be described.

FIG. 1 is a block diagram illustrating a quantum circuit simulation method and device according to several embodiments of the present disclosure.

Referring to FIG. 1, the quantum circuit simulation method according to several embodiments of the present disclosure may be implemented through an electronic device 100. The electronic device 100 may include a processor 110, an input/output (I/O) device 120, a memory 130, an interface 140, and a bus 150. The processor 110, the I/O device 120, the memory 130, and/or the interface 140 may be interconnected via the bus 150. The bus 150 corresponds to a path through which data flows.

Specifically, the processor 110 may include at least one of a Central Processing Unit (CPU), Micro Processor Unit (MPU), Micro Controller Unit (MCU), Graphic Processing Unit (GPU), microprocessor, digital signal processor, microcontroller, financial application processor (AP), or other logic elements capable of performing similar functions.

The processor 110 and memory 130 in FIG. 1 may be configured as software on the electronic device 1000 or as separate hardware.

The input/output device 120 may include at least one of a keypad, keyboard, touchscreen, or display device.

The memory 130 may load data and/or programs, or the like. In this context, the memory 130 may function as an operational memory to enhance the performance of the processor 110 and may include high-speed DRAM and/or SRAM, or the like. The memory 130 may comprise one or more volatile memory devices, such as Double Data Rate Static DRAM (DDR SDRAM) or Single Data Rate SDRAM (SDR SDRAM), and/or one or more non-volatile memory devices, such as Electrically Erasable Programmable ROM (EEPROM) or flash memory.

The interface 140 may function to transmit data to or receive data from a communication network. The interface 140 may be either wired or wireless. For example, the interface 140 may include an antenna or wired/wireless transceiver.

The input/output device 120 may be applied to personal digital assistants (PDAs), portable computers, web tablets, wireless phones, mobile phones, digital music players, memory cards, or any electronic product capable of transmitting and/or receiving information in a wireless environment.

In addition, the quantum circuit simulation device according to the embodiments of the present disclosure may consist of a plurality of electronic devices 100 each interconnected via a network. In such cases, each module or combination of modules may be implemented through the electronic device 100. However, these embodiments are not limited to this configuration.

Furthermore, the quantum circuit simulation device may be implemented as at least one of a workstation, a data center, an internet data center (IDC), a direct attached storage (DAS) system, a storage area network (SAN) system, a network attached storage (NAS) system, or a redundant array of inexpensive disks or redundant array of independent disks (RAID) system. These embodiments are not limited to the mentioned systems.

The quantum circuit simulation device may also transmit data via a network. The network may include wired internet technologies, wireless internet technologies, and short-range communication technologies. Wired internet technologies may include, for example, at least one of a local area network (LAN) or a wide area network (WAN).

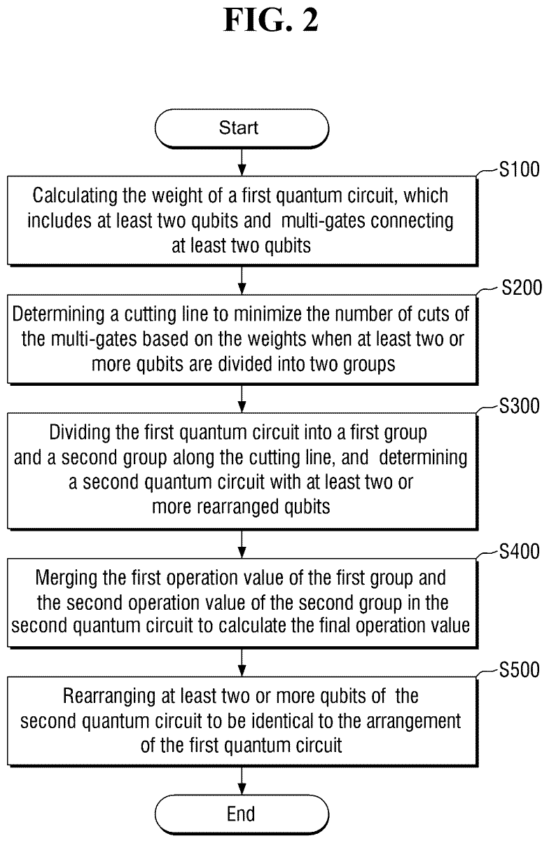

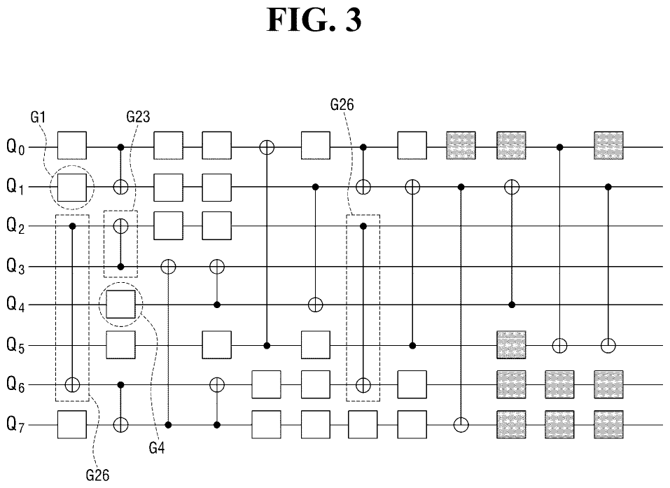

FIG. 2 is a flowchart illustrating the quantum circuit simulation method according to several embodiments of the present disclosure. FIG. 3 is a diagram illustrating a quantum circuit including qubits, single gates, and multi-gates as depicted in FIG. 2.

Referring to FIGS. 2 and 3, the weight of a first quantum circuit, which includes at least two qubits and multi-gates connecting at least two qubits, may be calculated (S100).

The first quantum circuit may refer to a quantum gate circuit used in a quantum information system. Quantum information may refer to information about the state of a quantum system. The first quantum circuit may include qubits and gates. A qubit may refer to a basic unit of computation in quantum computer. A qubit may refer to a quantum bit, which is a combination of a bit and a quantum, which is the basic unit of computation in classical computer. A bit is a unit that represents on-off states and may be expressed as 0 or 1. However, a qubit, while based on on-off states, may exist in a superposition of both states simultaneously. That is, a single qubit may represent a quantum superposition of 0 and 1.

In FIG. 3, a single gate may be represented by a rectangle. A single gate may refer to a gate that utilizes one qubit. Specifically, a single gate may include at least one of a Hadamard gate, Pauli-X gate, Pauli-Y gate, Pauli-Z gate, square root gate, or rotation gate.

In this case, the Hadamard gate may refer to a gate that creates a superposition state. Additionally, the Pauli-X gate may refer to a gate that rotates the state by 180 degrees around the x-axis of the Bloch sphere, while the Pauli-Y gate may refer to a state-changing gate that rotates the state by 180 degrees around the y-axis of the Bloch sphere. The Pauli-Z gate may refer to a state-changing gate that rotates the state by 180 degrees around the z-axis of the Bloch sphere. The square root gate may take various forms depending on the axis of rotation. For example, if the rotation occurs around the x-axis, the square root gate may be referred to as a square root X gate. In this case, the square root X gate refers to a gate that rotates the state by 90 degrees around the x-axis.

Further, a rotation gate may refer to a gate that rotates the state by a multiple of a specific angle. In this case, the specific angle may be, for example, 22.5 degrees. In this case, the rotation gate may rotate a qubit by 22.5, 45, 90, or 135 degrees around the x-axis.

A multi-gate may refer to a gate that utilizes two or more qubits. In this case, the value of the second qubit may be determined by the value of the first qubit. Naturally, multi-gates may include both double gates and triple gates. A double gate may operate on two qubits.

Specifically, double gates may include a CNOT gate and a SWAP gate. A CNOT gate applies a Pauli-X gate to the second qubit when the first qubit is in the 1 state. For this reason, the CNOT gate is also referred to as a controlled-X gate (CX gate). Meanwhile, a SWAP gate may refer to a gate that swaps the states of two qubits.

A triple gate may refer to a gate that utilizes three qubits. Specifically, it may include a CCNOT gate, also referred to as a Toffoli gate. The CCNOT gate may refer to a gate that adds a control qubit to the CNOT gate. The CCNOT gate applies a Pauli-X gate to the third qubit when both the first and second qubits are in the 1 state.

In this case, the weight calculated in the first quantum circuit may include the number of multi-gates that utilize qubits. The details of the weight will be further explained later.

The first quantum circuit may be represented in a quantum circuit diagram. Qubits may be represented as horizontal lines in the quantum circuit diagram. In other words, the number of horizontal lines may correspond to the number of qubits. Specifically, in FIG. 3, eight qubits may be represented by eight horizontal lines. In this case, each horizontal line may represent Q₀ through Q₇. However, the number of qubits may vary in this embodiment.

A single gate may be represented as a rectangle in the quantum circuit diagram. The type of gate may be indicated by displaying characters within the rectangle. Specifically, the fourth gate G4 may refer to a single gate that utilizes the fourth qubit Q₄.

The first gate G1 may refer to a single gate that utilizes the first qubit Q₁. In this case, there may be two or more single gates that utilize the first qubit Q₁. That is, multiple single gates may utilize the same qubit.

Multi-gates may be represented as vertical lines in the quantum circuit diagram. Specifically, the 23rd gate G23 may refer to a double gate that utilizes the second qubit Q₂ and the third qubit Q₃. That is, the state of the third qubit Q₃ may be determined by the state of the second qubit Q₂. As described above, a double gate that utilize the n-th qubit and the m-th qubit may be defined as the mn-th gate.

Meanwhile, the 26th gate G26 may refer to a double gate that utilize the second qubit Q₂ and the sixth qubit Q₆. In this case, there may be two or more double gates that utilize the second qubit Q₂ and the sixth qubit Q₆. That is, there may be a plurality of double gates utilizing the same qubit.

Next, when at least two or more qubits are divided into two groups, a cutting line may be determined to minimize the number of cuts of the multi-gates based on the weights (S200).

The number of cuts and the cutting line may be represented in a weighted graph. The weighted graph may be generated based on the calculated weights. The cutting line refers to the line on the weighted graph that minimizes the number of cuts of the multi-gates. The number of cuts represents how many multi-gates are divided along the cutting line on the weighted graph. The details of the weighted graph will be further explained later.

Next, the first quantum circuit may be divided into a first group and a second group along the cutting line, and a second quantum circuit with at least two or more rearranged qubits may be determined (S300).

The first group and the second group may be generated based on the weighted graph. Specifically, the first and second groups may each include at least one qubit. Additionally, qubits belonging to the first and second groups may be separated on the weighted graph. The second quantum circuit may refer to a quantum circuit generated in the process of rearranging the separated qubits by group.

Subsequently, the first operation value of the first group and the second operation value of the second group in the second quantum circuit may be merged to calculate the final operation value (S400).

The first operation value may represent the simulation result of the quantum circuit for the first group, and the second operation value may represent the simulation result of the quantum circuit for the second group. Therefore, the final operation value may refer to the quantum circuit simulation result for the input first quantum circuit.

Next, at least two or more qubits of the second quantum circuit may be rearranged to be identical to the arrangement of the first quantum circuit (S500).

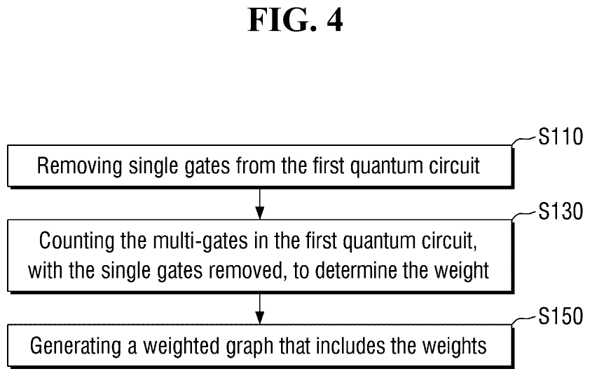

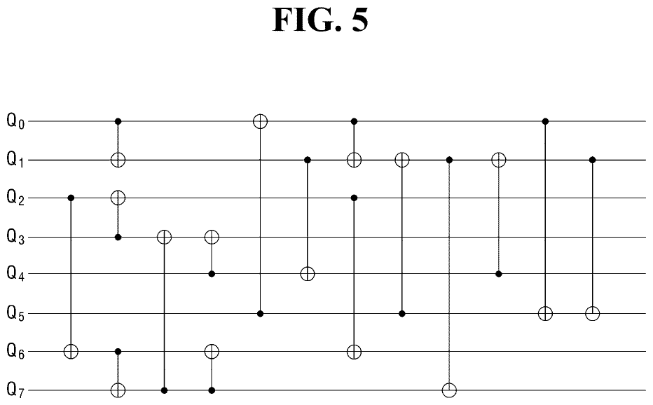

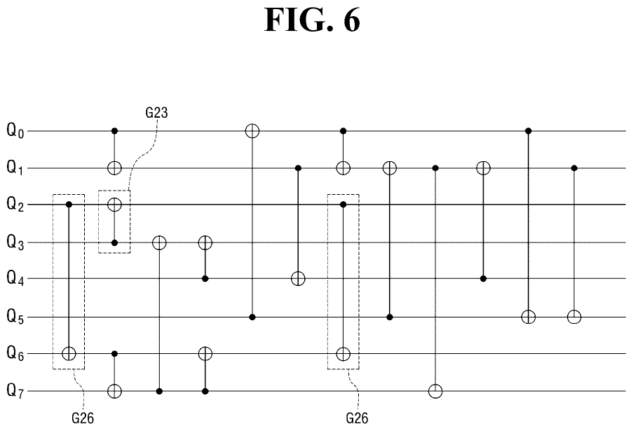

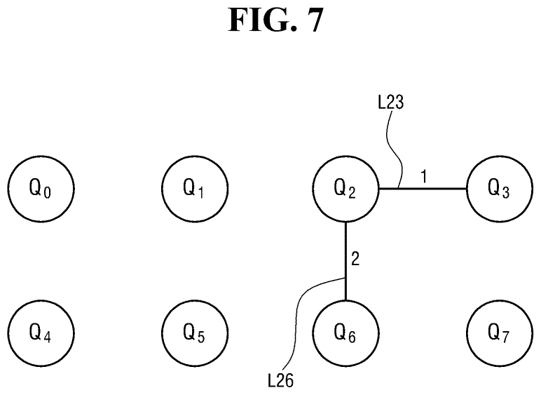

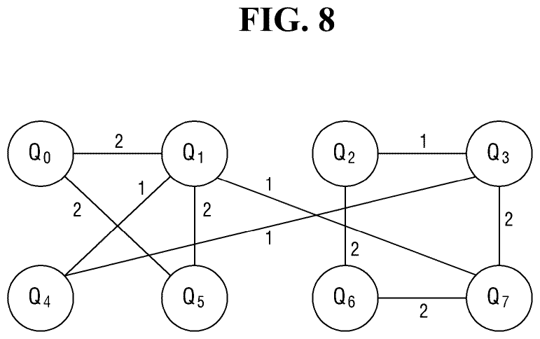

FIG. 4 is a flowchart illustrating the process of calculating the weight of the first quantum circuit in FIG. 1. FIG. 5 is a diagram illustrating the preprocessed quantum circuit for generating the weighted graph of FIG. 4. FIG. 6 is a diagram for explaining the method of calculating the weight in FIG. 4. FIG. 7 is a diagram illustrating a portion of the weighted graph in FIG. 4. FIG. 8 is a diagram illustrating the entire weighted graph in FIG. 4.

Referring to FIGS. 3 through 6, single gates may be removed from the first quantum circuit (S110).

Specifically, referring to FIG. 5, rectangles placed on the horizontal line corresponding to the 0th qubit Q₀ may be removed. In the same way, all rectangles placed on the horizontal lines corresponding to the first to seventh qubits Q₁ to Q₇ may be removed.

For example, the first gate G1 may be placed on the horizontal line corresponding to the first qubit Q₁. Similarly, the fourth gate G4 may be placed on the horizontal line corresponding to the fourth qubit Q₄. At this point, both the first and fourth gates G1 and G4 may be removed. In other words, when the fourth gate G4 is removed, the horizontal line corresponding to the fourth qubit Q₄ may contain part of a multi-gate. That is, a vertex of the multi-gate may be included in the horizontal line corresponding to the fourth qubit Q₄. As another example, the horizontal line corresponding to the second qubit Q₂ may contain vertices of the 26th gate G26 and the 23rd gate G23.

Referring again to FIG. 3, the multi-gates in the first quantum circuit, with the single gates removed, may be counted to determine the weight (S130).

Specifically, referring to FIG. 6, the multi-gates that utilize each qubit may be counted. For example, the 26th gate G26, which utilizes the second qubit Q₂ and the sixth qubit Q₆, may be counted as two. In this case, the weight may be determined as 2. Additionally, the 23rd gate G23, which utilizes the second qubit Q₂ and the third qubit Q₃, may be counted as one, and the weight may be determined as 1.

Referring again to FIG. 3, a weighted graph that includes the weights may be generated (S150).

Specifically, referring to FIGS. 6 through 8, the weighted graph may include circles, straight lines, and numbers. Each circle may represent a qubit. In other words, the weighted graph may include a number of circles corresponding to the number of qubits. For example, the 0th to seventh qubits Q₀ to Q₇ may be represented by eight circles.

Additionally, a straight line may represent a multi-gate. In this case, the weighted graph may include straight lines corresponding to the multi-gates that utilize each qubit. For example, the 23rd gate G23 may be represented by a straight line L23 connecting the circle corresponding to the second qubit Q₂ and the circle corresponding to the third qubit Q₃. Similarly, the 26th gate G26 may be represented by a straight line L26 connecting the circle corresponding to the second qubit Q₂ and the circle corresponding to the sixth qubit Q₆.

Additionally, numbers may represent the weights. In this case, the weighted graph may include numbers around the straight lines, corresponding to the number of multi-gates. For instance, since the weight of the 23rd gate G23 is 1, the number 1 may be expressed around the straight line L23 that connects the circles corresponding to the second qubit Q₂ and the third qubit Q₃. Similarly, since the weight of the 26th gate G26 is 2, the number 2 may be expressed around the straight line L26 that connects the circles corresponding to the second qubit Q₂ and the sixth qubit Q₆.

In the same way, a weighted graph may be generated by utilizing the multi-gates that connect each qubit and their corresponding weights.

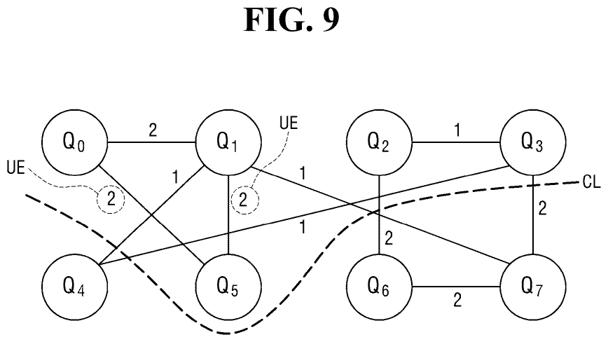

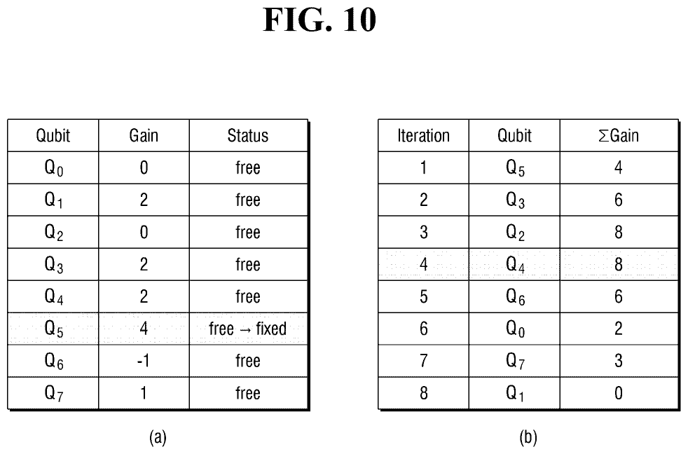

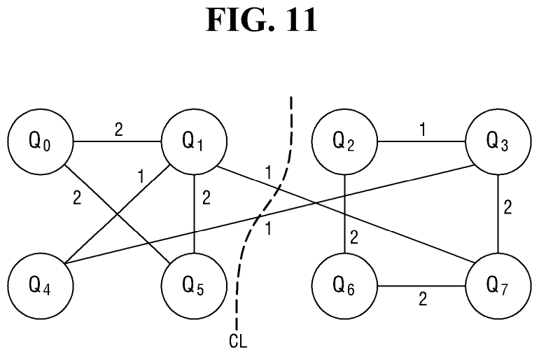

FIG. 9 is a diagram illustrating the method of determining the number of cuts along the cutting line of FIG. 2. FIG. 10 is a diagram illustrating the calculation process to minimize the number of cuts in FIG. 2. FIG. 11 is a diagram illustrating the method of determining the cutting line with the minimized number of cuts in FIG. 2.

Referring to FIGS. 2 and 9 through 11, an algorithm may be used to determine the cutting line. Specifically, the cutting line may be determined using a partitioning algorithm that divides the number of qubits. In this case, the partitioning algorithm may be an algorithm that minimizes the number of cuts in the multi-gates.

The cutting line may be determined using the Fiduccia-Mattheyses algorithm (FM algorithm) or the Kernighan-Lin algorithm (K-L algorithm). Additionally, algorithms for determining the cutting line may include simulated annealing, spectral partitioning, multilevel partitioning, and recursive bisection. The following description assumes the use of the FM algorithm.

When all qubits are divided into two groups by an arbitrary cutting line, the gain value may be calculated by moving a qubit to the other group. Specifically, the gain value is a value obtained by subtracting the number of multi-gates that are divided from the number of multi-gates that are not divided by moving a qubit to the other group. In other words, if the number of undivided multi-gates increases after the move than before the move, the gain value will be positive.

Specifically, if the qubits are divided into the 0th to third qubits Q₀ to Q₃ and the fourth to seventh qubits Q₄ to Q₇, the gain value (Gain) may be calculated for each qubit when moved to the other group. As an example, when the 0th qubit Q₀ is moved to the other group, the number of undivided multi-gates is 2, and the number of divided multi-gates is also 2. Therefore, the gain value for the 0th qubit Q₀ is 0.

As another example, the gain value for the fifth qubit Q₅ may be calculated. When the fifth Q₅ is moved to the other group, the 0th to third qubits Q₀ to Q₃ and the fifth Q₅ may be included in one group, while the fourth, sixth, and seventh qubits Q₄, Q₆, and Q₇ may be included in the other group. In this case, by moving the fifth qubit Q₅, the number of undivided multi-gates (UE) will be 4, and the number of divided multi-gates will be 0. Therefore, the gain value for the fifth qubit Q₅ is 4. The gain value for each qubit may be calculated in the same manner.

By comparing the gain values of each qubit, the state of the qubits may be determined. That is, the qubit with the highest gain value is set to the fixed state, while the remaining qubits are set to the free state. A qubit in the fixed state no longer requires gain value calculation. In contrast, qubits in the free state will continue to have their gain values recalculated.

For example, if the gain values for the 0^{th} to seventh qubits Q₀ to Q₇ are calculated and the gain value for the fifth qubit Q₅ is the highest, the fifth qubit Q₅ may be set to the fixed state. In this case, the 0^{th} to fourth, sixth, and seventh qubits Q₀ to Q₄, Q₆, and Q₇ may remain in the free state. The gain values for the 0^{th} to fourth, sixth, and seventh qubits Q₀ to Q₄, Q₆, and Q₇ will then be recalculated to determine their states. The gain calculation process is repeated, and at each step, one qubit is set to the fixed state.

At the end of each step, the total gain value (ΣGain) may be calculated. Specifically, if the fifth qubit Q₅ is fixed in the first step, the total gain value may be 4. If the third qubit Q₃ is fixed in the second step, the total gain value may be 6. Subsequently, if the second qubit Q₂ is fixed in the third step, the total gain value may be 8. However, if the fourth qubit Q₄ is fixed in the fourth step, the total gain value remains 8, and if the sixth qubit Q₆ is fixed in the fifth step, the total gain value may decrease to 6. In other words, the total gain value may decrease from a certain step. Therefore, the step before the decrease in the total gain value may be selected as the optimal step.

Ultimately, the qubits may be divided in a way that maximizes the total gain value. That is, the cutting line may be determined. Specifically, a cutting line CL may be determined by dividing the 0th, first, fourth, and fifth qubits Q₀, Q₁, Q₄, and Q₅ into one group and the second, third, sixth, and seventh qubits Q₂, Q₃, Q₆, and Q₇ into the other group.

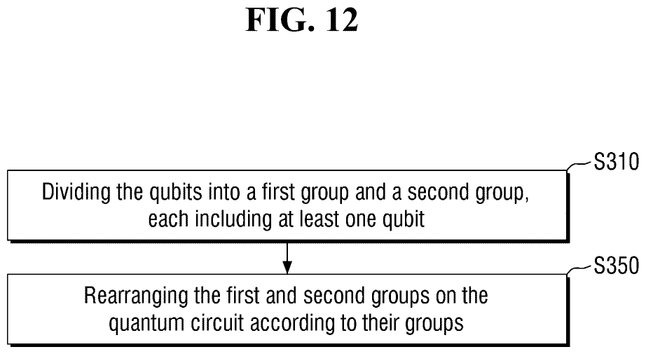

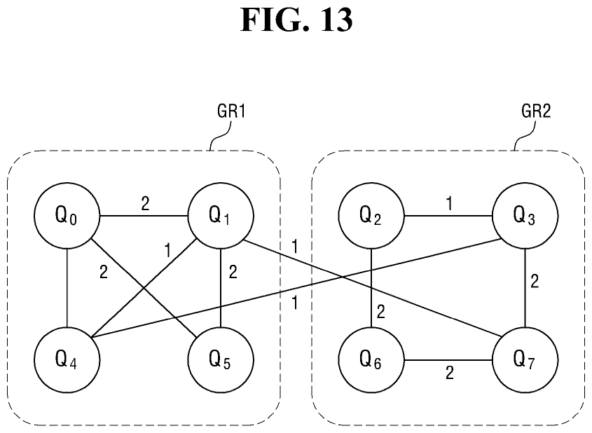

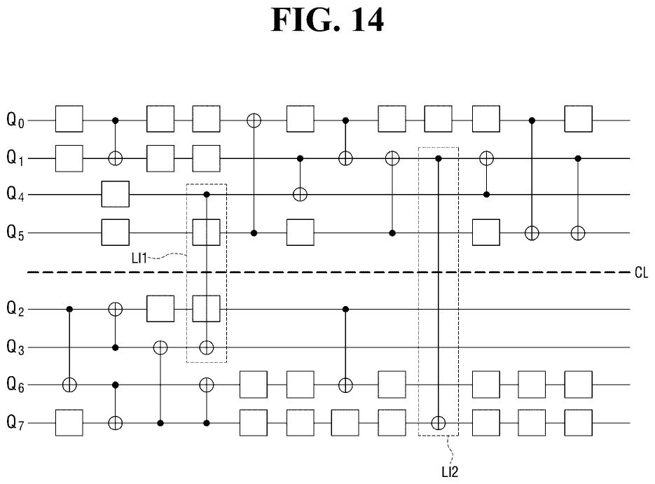

FIG. 12 is a flowchart detailing the step of determining the second quantum circuit in FIG. 2. FIG. 13 is a diagram illustrating the first group and the second group from FIG. 12. FIG. 14 is a diagram illustrating the second quantum circuit from FIG. 12.

Referring to FIGS. 11 to 14, the qubits may be divided into a first group and a second group, each including at least one qubit (S310).

Specifically, the first group and the second group GR1, and GR2 may be determined according to the cutting line CL. That is, the qubits divided by the cutting line CL may be included in their respective groups. However, both the first group and the second group GR1, and GR2 may include at least one qubit. That is, the first group GRI may include one qubit, while the second group GR2 may include the remaining qubits. The first group GRI may include, for example, the 0th, first, fourth, and fifth qubits Q₀, Q₁, Q₄, and Q₅, which are divided by the cutting line CL in one direction. Similarly, the second group GR2 may include the second, third, sixth, and seventh qubits Q₂, Q₃, Q₆, and Q₇, which are divided by the cutting line CL in the other direction.

Meanwhile, the first and second groups GR1, and GR2 may contain different numbers of qubits. That is, if the first quantum circuit includes (n+m) qubits (where n and m are natural numbers), the first group GR1 may include n qubits, and the second group GR2 may include m qubits. In this case, n and m may be equal, or the difference between n and m may be at least 1.

Next, the first and second groups may be rearranged on the quantum circuit according to their groups (S350).

Referring to FIG. 14, the second quantum circuit may be a quantum circuit where the first quantum circuit is rearranged by groups. In this case, the second quantum circuit may include qubits, single gates, and multi-gates. Specifically, the qubits in the first group GR1 may be arranged in the order of the 0th, first, fourth, and fifth qubits Q₀, Q₁, Q₄, and Q₅. Similarly, the qubits in the second group GR2 may be arranged in the order of the second, third, sixth, and seventh qubits Q₂, Q₃, Q₆, and Q₇. Therefore, the second quantum circuit may be arranged in the order of the 0th, first, fourth, fifth, second, third, sixth, and seventh qubits Q₀, Q₁, Q₄, Q₅, Q₂, Q₃, Q₆, and Q₇. In other words, the second quantum circuit may differ from the first quantum circuit in terms of the order of the qubits.

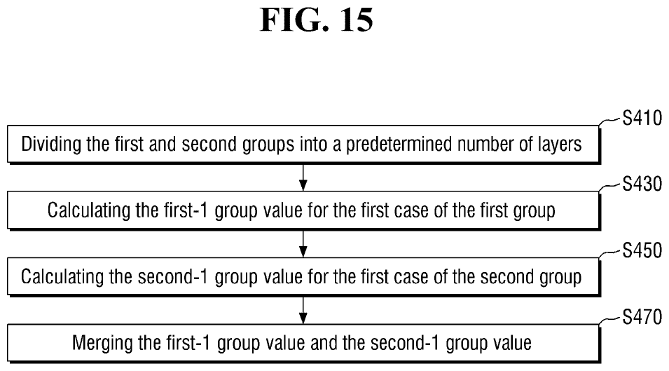

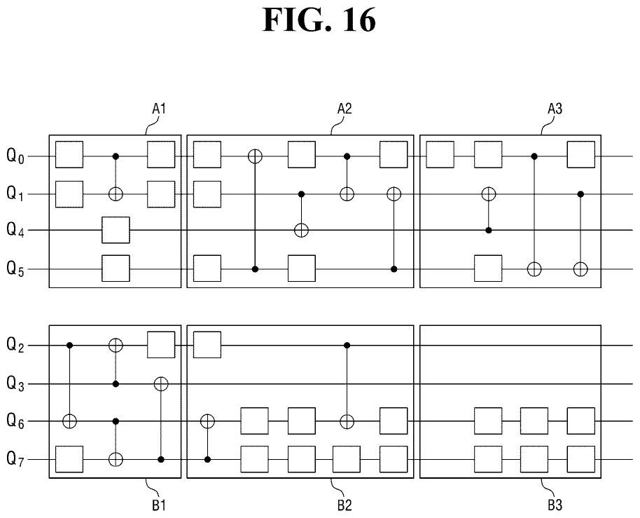

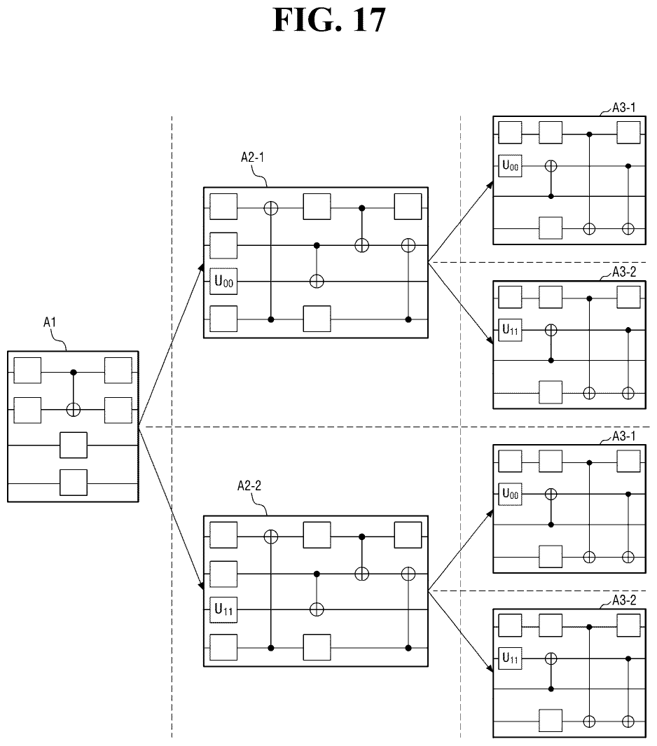

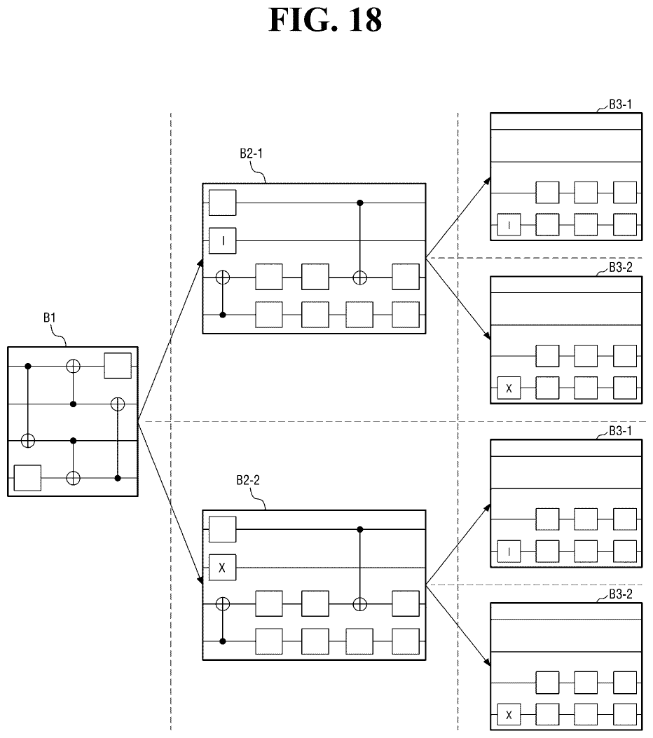

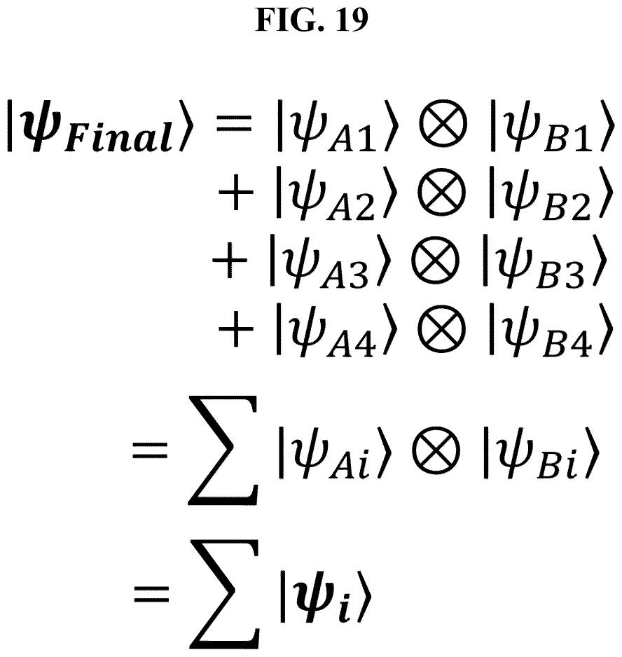

FIG. 15 is a flowchart detailing the step of calculating the final operation value in FIG. 2. FIG. 16 is a diagram illustrating the layers into which the first group and the second group from FIG. 14 are divided. FIG. 17 illustrates the method of calculating the first-1 group value in FIG. 15. FIG. 18 shows the method of calculating the second-1 group value in FIG. 15. FIG. 19 represents the formula for calculating the final operation value using the first-1 group value and the second-1 group value in FIG. 15.

Referring to FIGS. 13 to 16, the first and second groups may be divided into a predetermined number of layers (S410).

In this case, the predetermined number may be greater than the number of possible cases of multi-gates. Specifically, when dividing the first and second groups, the multi-gates divided by the cutting line CL may be two. That is, the first multi-gate LI1 and the second multi-gate LI2 may be divided by the cutting line CL. Additionally, the first multi-gate LI1 may be connected to the third qubit Q₃ and the fourth qubit Q₄, while the second multi-gate LI2 may be connected to the first qubit Q₁ and the seventh qubit Q₇.

At this point, the first group GR1 may be divided into three layers, which is more than the number of divided multi-gates. Specifically, the first group GR1 may be divided into layer A1, layer A2, and layer A3 with the first multi-gate LI1 and the second multi-gate LI2 as boundaries.

The second group GR2 may also be divided into three layers, which is more than the number of divided multi-gates. Specifically, the second group GR2 may be divided into layer B1, layer B2, and layer B3 with the first multi-gate LI1 and the second multi-gate LI2 as boundaries.

Referring again to FIG. 15, the first-1 group value for the first case of the first group may be calculated (S430).

Specifically, referring to FIG. 17, if the first multi-gate LI1 corresponds to the first case, layer A2 may have the structure of layer A2-1. Additionally, if the first multi-gate LI1 corresponds to the second case, layer A2 may have the structure of layer A2-2. In other words, layer A2 may be determined to have a structure of either layer A2-1 or layer A2-2, depending on the first multi-gate LI1.

If the second multi-gate LI2 corresponds to the first case, layer A3 may have the structure of layer A3-1. Similarly, if the second multi-gate LI2 corresponds to the second case, layer A3 may have the structure of layer A3-2. In other words, layer A3 may be determined to have the structure of either layer A3-1 or layer A3-2, depending on the first and second multi-gates LI1 and LI2.

A first-1 group value ψ_{A1} may refer to the simulation result of the first group GRI for the first case. Specifically, the first-1 group value ψ_{A1} may represent the simulation result when layer A2 has the structure of layer A2-1, and layer A3 has the structure of layer A3-1.

Additionally, the first-2 group value ψ_{A2} may refer to another simulation result of the first group GR1. Specifically, the first-2 group value ψ_{A2} may represent the simulation result when layer A2 has the structure of layer A2-1, and layer A3 has the structure of layer A3-2.

The first-3 group value ψ_{A3} may refer to another simulation result of the first group GR1. Specifically, the first-3 group value ψ_{A3} represents the simulation result when layer A2 has the structure of layer A2-2, and layer A3 has the structure of layer A3-1.

Additionally, the first-4 group value ψ_{A4} may refer to the simulation result of the first group GR1 for the second case. Specifically, the first-4 group value ψ_{A4} represents the simulation result when layer A2 has the structure of layer A2-2, and layer A3 has the structure of layer A3-2.

The first operation value may include the first-1 to first-4 group values ψ_{A1} to ψ_{A4}. In other words, the first operation value represents the result calculated for the first group GR1 according to the first and second cases of the first multi-gate LI1 and the second multi-gate LI2.

The first operation value may be derived using depth-first search (DFS). Depth-first search may refer to a method of searching in a layer structure by preferentially selecting adjacent layers to the current layer.

Referring again to FIG. 15, the second-1 group value for the first case of the second group may be calculated (S450).

Specifically, referring to FIG. 18, if the first multi-gate LI1 corresponds to the first case, layer B2 may have the structure of layer B2-1. Additionally, if the first multi-gate LI1 corresponds to the second case, layer B2 may have the structure of layer B2-2. In other words, layer B2 may be determined to have the structure of either layer B2-1 or layer B2-2, depending on the first multi-gate LI1.

Similarly, if the second multi-gate LI2 corresponds to the first case, layer B3 may have the structure of layer B3-1. If the second multi-gate LI2 corresponds to the second case, layer B3 may have the structure of layer B3-2. In other words, layer B3 may be determined to have the structure of either layer B3-1 or layer B3-2, depending on the first and second multi-gates LI1 and LI2.

The second-1 group value ψ_{B1} may refer to the simulation result of the second group GR2 for the first case. Specifically, the second-1 group value ψ_{B1} may refer to the simulation result when layer B2 has the structure of layer B2-1, and layer B3 has the structure of layer B3-1.

Additionally, the second-2 group value ψ_{B2} may refer to another simulation result of the second group GR2. Specifically, the second-2 group value ψ_{B2} may refer to the simulation result when layer B2 has the structure of layer B2-1, and layer B3 has the structure of layer B3-2.

The second-3 group value ψ_{B3} may refer to yet another simulation result of the second group GR2. Specifically, the second-3 group value ψ_{B3} may refer to the simulation result when layer B2 has the structure of layer B2-2, and layer B3 has the structure of layer B3-1.

Lastly, the second-4 group value ψ_{B4} may refer to the simulation result of the second group GR2 for the second case. Specifically, the second-4 group value ψ_{B4} may refer to the simulation result when layer B2 has the structure of layer B2-2, and layer B3 has the structure of layer B3-2.

The second operation value may include the second-1 to second-4 group values ψ_{B1} to ψ_{B4}. In other words, the second operation value may represent the result calculated for the second group GR2 according to the first and second cases of the first multi-gate LI1 and the second multi-gate LI2. This second operation value may be derived using depth-first search (DFS).

Referring again to FIG. 15, the first-1 group value and the second-1 group value may be merged (S470).

Specifically, referring to FIG. 19, the final operation value may include the merged values of the first and second operation values. The final operation value may include the merged values of the first to fourth intermediate operation values ψ₁ to ψ₄. The final operation value may include the sum of the first to fourth intermediate operation values ψ₁ to ψ₄.

That is, the first intermediate operation value ψ₁ may be the result of merging the first-1 group value ψ_{A1} and the second-1 group value ψ_{B1}. In other words, the first intermediate operation value ψ₁ may be the result of merging the first-1 group value ψ_{A1} and the second-1 group value ψ_{B1} using a predefined method. This predefined method may include the Kronecker product, which refers to the tensor product of two matrices. Therefore, the first intermediate operation value ψ₁ may be the Kronecker product of the first-1 group value ψ_{A1} and the second-1 group value ψ_{B1}.

Additionally, the second intermediate operation value ψ₂ may be the result of merging the first-2 group value ψ_{A2} and the second-2 group value ψ_{B2}. In other words, the second intermediate operation value ψ₂ may be the Kronecker product of the first-2 group value ψ_{A2} and the second-2 group value ψ_{B2}.

Similarly, the third intermediate operation value ψ₃ may be the result of merging the first-3 group value ψ_{A3} and the second-3 group value ψ_{B3}. That is, the third intermediate operation value ψ₃ may be the Kronecker product of the first-3 group value ψ_{A3} and the second-3 group value ψ_{B3}.

Additionally, the fourth intermediate operation value ψ₄ may be the result of merging the first-4 group value ψ_{A4} and the second-4 group value ψ_{B4}. In other words, the fourth intermediate operation value ψ₄ may be the Kronecker product of the first-4 group value ψ_{A4} and the second-4 group value ψ_{B4}.

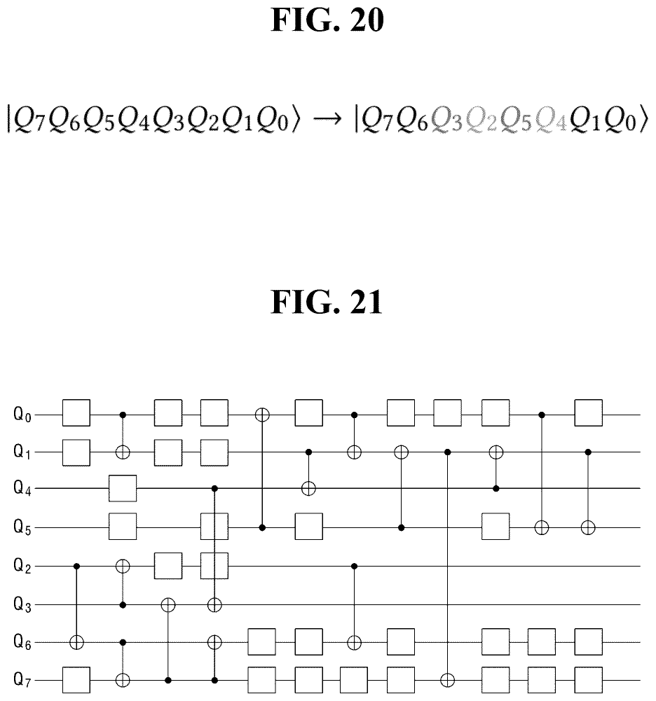

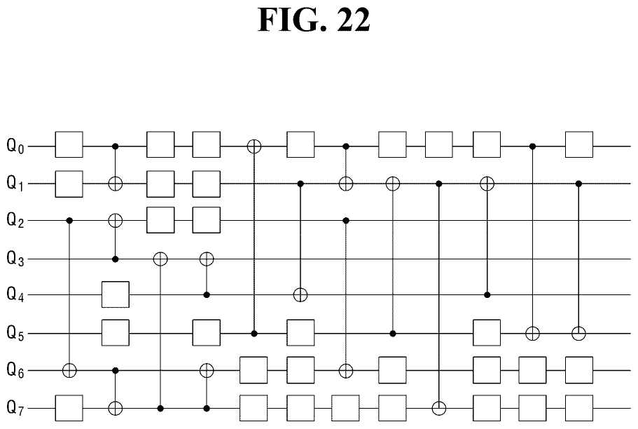

FIG. 20 is a diagram illustrating the qubit arrangement order before and after the rearrangement of the second quantum circuit in FIG. 2. FIG. 21 is a diagram illustrating the second quantum circuit before rearrangement in FIG. 2. FIG. 22 is a diagram illustrating the second quantum circuit after rearrangement in FIG. 2.

Referring to FIGS. 16 and 20 to 22, the qubit arrangement order may change during the process of generating the second quantum circuit.

In some embodiments, the qubit order of the second quantum circuit may be rearranged. Specifically, the qubit order of the second quantum circuit may be rearranged to match the qubit order of the first quantum circuit. In this process, bit masking may be utilized. Bit masking may refer to a technique for creating or extracting specific bit patterns.

Specifically, a result vector containing the quantum simulation results may exist. Using the index values in the result vector, the values of individual qubits may be swapped. In other words, bit masking may be used to extract the bit values of the fifth qubit Q₅ and the third qubit Q₃, allowing the values of the third qubit Q₃ and fifth qubit Q₅ to be swapped each other.

The quantum circuit simulation device and method according to some embodiments of the present disclosure may derive the result for a quantum circuit in the same form as the input by replacing matrix multiplication with bit-level operations.

Additionally, the present disclosure may reduce the time required to restore the qubit order by utilizing bit operations.

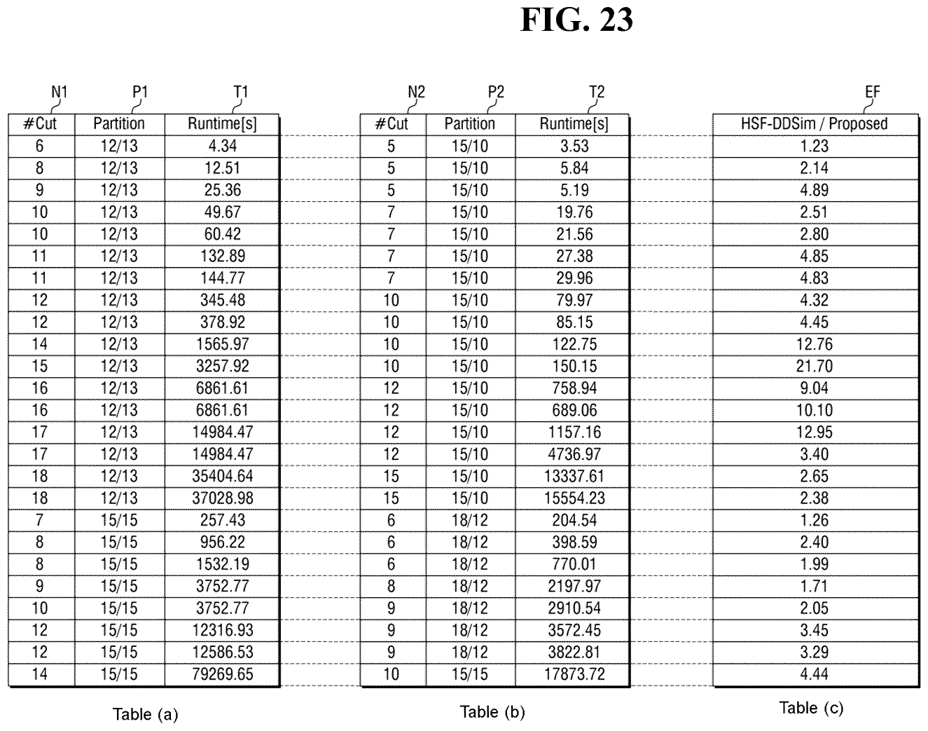

FIG. 23 is a chart comparing the efficiency before and after the rearrangement in FIG. 2.

Referring to FIGS. 2 and 23, Table (a) may include the simulation efficiency when the qubits of the quantum circuit are divided into two halves without any specific rules.

In Table (a), a first number of cuts N1 represents the number of multi-gates that are divided. Additionally, a first partition P1 may indicate the number of qubits included in each group. In this case, the first partition P1 may correspond to dividing all the qubits in half without any rules. If the number of qubits is odd, the qubits may be divided with a difference of 1 in their count. Specifically, if there are (2n+1) qubits (where n is a natural number), they may be divided into n and (n+1) qubits. On the other hand, if the number of qubits is even, they may be divided into equal counts. Specifically, if there are 2n qubits, they may be divided into n and n qubits. As a result, the first runtime T1 may represent the simulation time when P1 is divided by the first number of cuts N1.

In Table (b), a second number of cuts N2 may represent the number of multi-gates that are divided. Additionally, a second partition P2 indicates the number of qubits included in each group. In this case, the second partition P2 may correspond to dividing all the qubits in a way that minimizes the number of cuts. That is, the qubits may be divided into two groups regardless of whether the total number of qubits is odd or even. In other words, the second partition P2 may divide the qubits into n and m qubits (where m is a natural number).

Specifically, if there are 25 qubits, the first partition P1 may be fixed to divide the qubits into 12 and 13. In contrast, the second partition P2 may divide the qubits into 15 and 10. Additionally, if there are 30 qubits, the first partition P1 may divide the qubits into 15 and 15. Similarly, the second partition P2 may also divide the qubits into 15 and 15. However, the second partition P2 may divide the qubits into 12 and 18. Furthermore, the second runtime T2 may represent the simulation time when the second partition P2 is divided by the second number of cuts N2.

Table (c) may represent the efficiency value EF, which is the ratio of the first runtime T1 to the second runtime T2. In other words, a higher efficiency value EF may indicate greater simulation efficiency.

The quantum circuit simulation device and method according to some embodiments of the present disclosure may minimize multi-gates, thereby reducing the total time required for quantum circuit simulation.

While the inventive concept has been particularly shown and described with reference to exemplary embodiments thereof, it will be understood by those of ordinary skill in the art that various changes in form and details may be made therein without departing from the spirit and scope of the inventive concept as defined by the following claims. It is therefore desired that the embodiments be considered in all respects as illustrative and not restrictive, reference being made to the appended claims rather than the foregoing description to indicate the scope of the disclosure.

What is claimed is:

1. A quantum circuit simulation device, comprising:
a memory;
a processor operatively connected to the memory, wherein the processor:
calculates the weight of a first quantum circuit including at least two qubits and multi-gates connecting the at least two qubits;
determines a cutting line that minimizes the number of cuts in the multi-gates based on the weight when dividing the at least two qubits into two groups;
determines a second quantum circuit by dividing the first quantum circuit into a first group and a second group along the cutting line, rearranging the at least two qubits;
calculates a final operation value by merging a first operation value of the first group and a second operation value of the second group in the second quantum circuit; and
rearranges the at least two qubits of the second quantum circuit to be the same as the first quantum circuit.

2. The quantum circuit simulation device of claim 1, wherein the calculating the weight of the first quantum circuit comprises:
removing a single gate that operates on one of the at least two qubits in the first quantum circuit;
determining the weight by counting the multi-gates in the first quantum circuit with the single gate removed; and
generating a weighted graph that includes the weight.

3. The quantum circuit simulation device of claim 2, wherein;
the qubits include a first qubit and a second qubit, and the generating the weighted graph includes displaying the number of first multi-gates connecting the first and second qubits.

4. The quantum circuit simulation device of claim 3, wherein:
the qubits further include a third qubit, and the generating the weighted graph further includes:
displaying the number of second multi-gates connecting the second and third qubits; and
displaying the number of third multi-gates connecting the third and first qubits.

5. The quantum circuit simulation device of claim 2, wherein the weighted graph includes straight lines corresponding to the multi-gates and numbers corresponding to the weights.

6. The quantum circuit simulation device of claim 2, wherein the determining the cutting line includes determining a line that divides the quantum circuit by minimizing the number of cuts in the multi-gates according to an algorithm.

7. The quantum circuit simulation device of claim 6, wherein the algorithm includes a Fiduccia-Mattheyses (FM) algorithm.

8. The quantum circuit simulation device of claim 6, wherein the number of cuts includes the number of multi-gates passing through the cutting line in the weighted graph.

9. The quantum circuit simulation device of claim 6, wherein the number of qubits in the first group is at least two greater than the number of qubits in the second group.

10. The quantum circuit simulation device of claim 1, wherein the determining the second quantum circuit includes:
dividing into the first and second groups, each including at least one qubit; and
rearranging the first and second groups on the quantum circuit according to their respective groups.

11. The quantum circuit simulation device of claim 1, wherein the calculating the final operation value includes:
dividing the first and second groups into a predetermined number of layers;
calculating the first-1 group value according to the first case of the multi-gates in the first group;
calculating the second-1 group value according to the first case of the multi-gates in the second group; and
merging the first-1 and second-1 group values.

12. The quantum circuit simulation device of claim 11, wherein the predetermined number is equal to the number of multi-gates.

13. A quantum circuit simulation method, comprising:
calculating the weight of a first quantum circuit that includes at least two qubits and multi-gates connecting the at least two qubits;
determining a cutting line that minimizes the number of cuts in the multi-gates based on the weight when dividing the at least two qubits into two groups;
determining a second quantum circuit by dividing the first quantum circuit into a first group and a second group along the cutting line, rearranging the at least two qubits;
calculating a final operation value by merging a first operation value of the first group and a second operation value of the second group in the second quantum circuit; and
rearranging the at least two qubits of the second quantum circuit to be the same as the first quantum circuit.

14. The quantum circuit simulation method of claim 13, wherein the calculating the final operation value comprises:
dividing the first and second groups into a number of layers greater than the number of multi-gates;
calculating a first-1 group value according to the first case of the multi-gates in the first group;
calculating a second-1 group value according to the first case of the multi-gates in the second group; and
merging the first-1 and second-1 group values.

15. The quantum circuit simulation method of claim 14, wherein the calculating the first-1 group value further includes:
calculating a first-4 group value according to a second case of the multi-gates in the first group, different from the first case.

16. The quantum circuit simulation method of claim 15, wherein the first operation value includes the first-1 group value and the first-4 group value.

17. The quantum circuit simulation method of claim 15, wherein the calculating the second-1 group value further includes:
calculating a second-4 group value according to a second case of the multi-gates in the second group.

18. The quantum circuit simulation method of claim 17, wherein the second operation value includes the second-1 group value and the second-4 group value.

19. The quantum circuit simulation method of claim 17, wherein the final operation value includes the sum of a first intermediate operation value, obtained by merging the first-1 group value and the second-1 group value, and a fourth intermediate operation value, obtained by merging the first-4 group value and the second-4 group value.

20. The quantum circuit simulation method of claim 14, wherein the calculating the final operation value includes utilizing depth-first search (DFS) on the layers.

21. The quantum circuit simulation method of claim 14, wherein the final operation value includes a value obtained by merging the first-1 group value and the second-1 group value using a predefined method.

22. The quantum circuit simulation method of claim 21, wherein the predefined method includes calculating the Kronecker product of the first-1 group value and the second-1 group value.
